(19) United States
(12) Patent Application Publication
(10) Pub. No.: US 2021/0281757 A1
(43) Pub. Date: Sep. 9, 2021

(54) IMAGING DEVICE AND IMAGING METHOD

(71) Applicant: Olympus Corporation, Tokyo (JP)

(72) Inventor: Yoko SAITO, Tokyo (JP)

(21) Appl. No.: 17/092,153

(22) Filed: Nov. 6, 2020

(30) Foreign Application Priority Data
Mar. 9, 2020 (JP) 2020-040048

(51) Int. Cl. H04N 5/232; H04N 1/00

(52) U.S. Cl. CPC H04N 5/23267; H04N 1/00084; H04N 2201/3284; H04N 2201/0077; H04N 1/00005

(57) ABSTRACT

An imaging device, comprising an image sensor that has a plurality of pixels, and outputs pixel data by forming an image using the plurality of pixels, and an image processing circuit that receives the pixel data from the image sensor by means of a transmission path, wherein the image sensor attaches special information at specified positions within rows of pixel data and outputs the data, and the image processing circuit detects the special information of the rows of pixel data, and identifies transmission errors for the transmission path based on results of detection of the special information.

### CROSS-REFERENCE TO RELATED APPLICATIONS

Benefit is claimed, under 35 U.S.C. § 119, to the filing date of prior Japanese Patent Application No. 2020-040048 filed on Mar. 9, 2020. This application is expressly incorporated herein by reference. The scope of the present invention is not limited to any requirements of the specific embodiments described in the application.

### BACKGROUND OF THE INVENTION

### 1. Field of the Invention

The present invention relates to an imaging device and an imaging method that can detect that transmission errors that have occurred within a transmission path of pixel data that has been output from an image sensor.

### 2. Description of the Related Art

An image that is incident on an image plane is converted to image data in an image sensor, and transmission errors may occur when transmitting this image data to an image processing section etc. It has therefore been proposed to subject image data that has been formed in the image sensor to error correction code processing (ECC processing), transmit this image data that has been subjected to ECC processing to an image processing section, and correct transmission errors of the image data by performing error correction decoding in the image processing section based on coded data (refer to Japanese patent laid-open No. 2012-105188 (hereafter referred to as patent publication 1)).

Correction using the above described error coding processing can correct image data in a case of small scale transmission errors within data of a single pixel. However, large-scale transmission errors sometimes occur, such as loss of a unit of pixel data due to increase in image data amount and increase in communication speed accompanying the increasing pixel counts of image sensors in recent years, and increase in pixel data due to double transmission. In this type of case correction of image data is not possible with error correction code processing, and image quality is lowered.

### SUMMARY OF THE INVENTION

The present invention provides an imaging device and an imaging method that can perform error correction, with no reduction in image quality, even if large-scale transmission errors have occurred.

An imaging device of a first aspect of the present invention comprises an image sensor that has a plurality of pixels, and outputs pixel data by forming an image using the plurality of pixels, and an image processing circuit that receives the pixel data from the image sensor by means of a transmission path, wherein the image sensor attaches and outputs special information to specified positions within rows of pixel data, and the image processing circuit detects the special information of the rows of pixel data, and identifies transmission errors for the transmission path based on results of detection of the special information.

An imaging method of a second aspect of the present invention comprises forming an image using a plurality of pixels of an image sensor and outputting pixel data, and receiving the pixel data from the image sensor by means of a transmission path, the imaging method comprising attaching and outputting special information to specified positions within rows of pixel data from the image sensor, and detecting the special information of the rows of pixel data, and identifying transmission errors for the transmission path based on results of detection of the special information.

A non-transitory computer-readable medium of a third aspect of the present invention, storing a processor executable code, which when executed by at least one processor, that is arranged within an imaging device that forms an image using a plurality of pixels of an image sensor and outputs pixel data, and receives the pixel data from the image sensor by means of a transmission path, performs an imaging method, the imaging method comprising attaching and outputting special information to specified positions within rows of pixel data from the image sensor, and detecting the special information of the rows of pixel data, and identifying transmission errors for the transmission path based on results of detection of the special information.

### BRIEF DESCRIPTION OF THE DRAWINGS

FIG. 1 is a block diagram mainly showing the electrical structure of a digital camera (hereafter abbreviated to camera) of one embodiment of the present invention.

FIG. 2 is a block diagram mainly showing the structure of a circuit associated with error correction of pixel data, in the image processing circuit of the camera of one embodiment of the present invention.

FIG. 3A to FIG. 3C are drawings for describing a case where pixel data transmitted from an image sensor to the image processing circuit is normal, and a case where the pixel data includes errors, in the camera of one embodiment of the present invention.

FIG. 4A to FIG. 4C are drawings were describing the attachment of error information, in the camera of one embodiment of the present invention.

FIG. 5A and FIG. 5B are drawings for describing image correction, in the camera of one embodiment of the present invention.

FIG. 6 is a flowchart for describing operation of start code detection, in the camera of one embodiment of the present invention.

FIG. 7 is a flowchart for describing operation of pixel data detection, in the camera of one embodiment of the present invention.

FIG. 8 is a flowchart for describing operation of pixel data count, in the camera of one embodiment of the present invention.

FIG. 9 is a flowchart for describing operation of error detection, in the camera of one embodiment of the present invention.

FIG. 10 is a flowchart for describing operation of pixel data rearranging, in the camera of one embodiment of the present invention.

FIG. 11 is a flowchart for describing operation of error information attachment, in the camera of one embodiment of the present invention.

FIG. 12 is a flowchart for describing operation of attachment error information analysis, in the camera of one embodiment of the present invention.

FIG. 13 is a flowchart for describing operation of pixel correction, in the camera of one embodiment of the present invention.

FIG. 14A to FIG. 14D are drawings for describing errors and special codes, within pixel data, with the camera of one embodiment of the present invention.

FIG. 15A to FIG. 15D are drawings showing range of a correction region, within pixel data, in the camera of one embodiment of the present invention.

### DETAILED DESCRIPTION OF THE PREFERRED EMBODIMENTS

An example where the present invention has been applied to a camera, as one embodiment of the present invention, will be described in the following. This camera has an imaging section, with a subject image being converted to image data by this imaging section, and the subject image being subjected to live view display on a display section arranged on the rear surface of the camera body based on this converted image data. A photographer determines composition and photo opportunity by looking at the live view display. At the time of a release operation image data is stored in a storage medium. Image data that has been stored in the storage medium can be subjected to playback display on the display section if playback mode is selected.

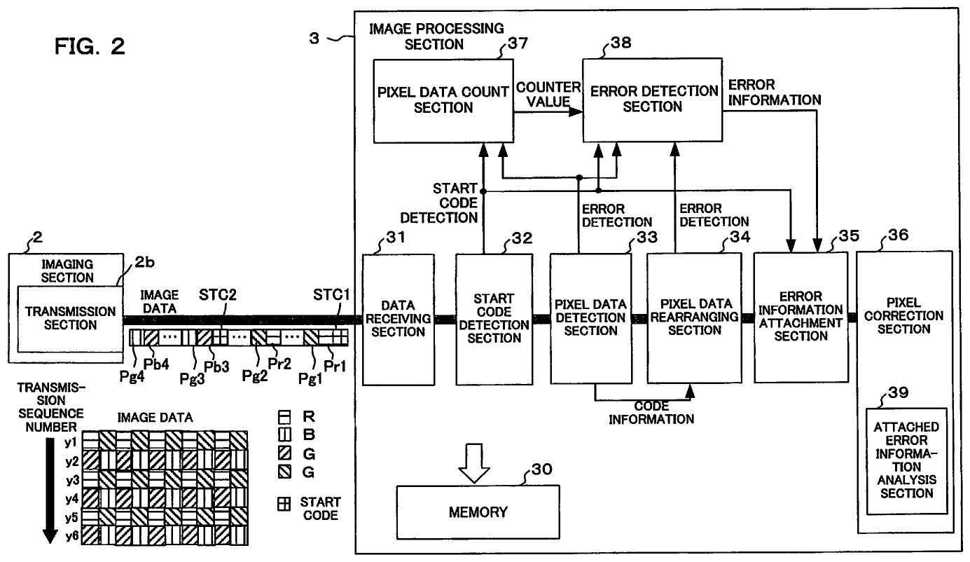

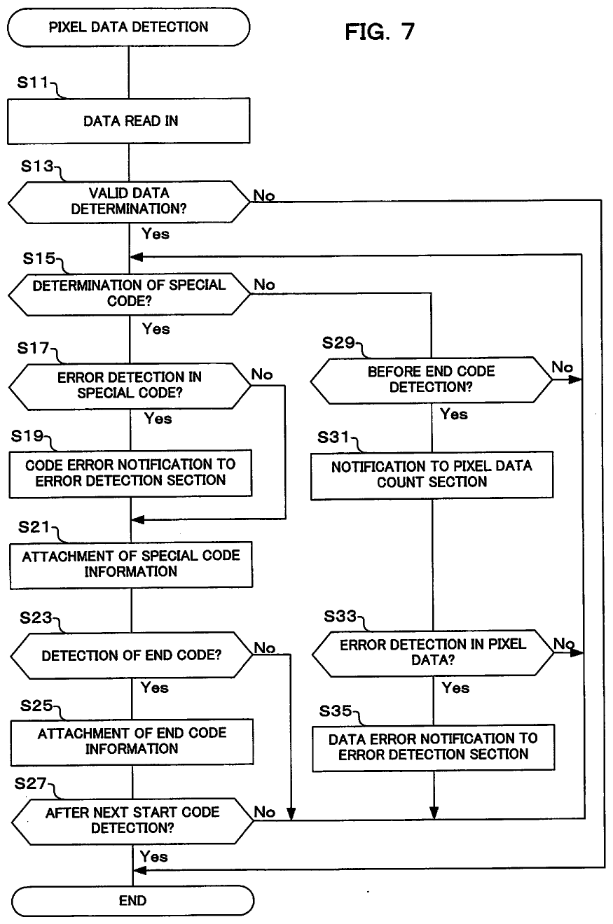

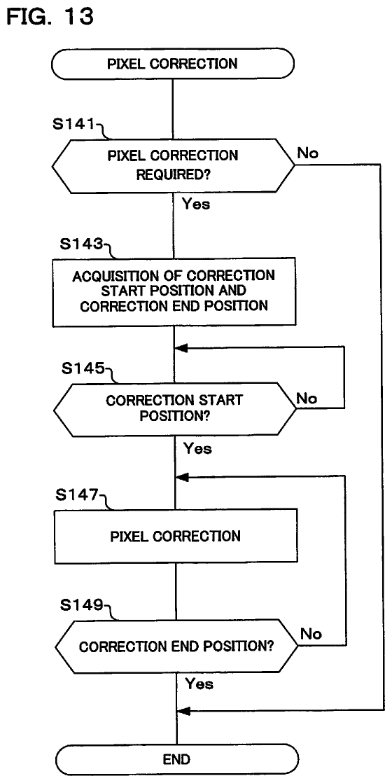

Also, the camera of this embodiment detects transmission errors of pixel data units that have occurred in a transmission path for image data from an image sensor to an image processing circuit, creates error information based on the results of this detection, and further corrects error occurring portions of the image data based on the error information. Specifically, the imaging section of the camera transmits image data to the image processing circuit by means of the transmission path. At the time of transmission of image data, the imaging section arranges special codes at specified positions within the image data, and this image data is then transmitted to the image processing circuit. The image processing circuit determines whether or not arrangement positions of the special codes are at specified positions, and detects whether or not errors have occurred during transmission based on the results of this determination (refer, for example, to the pixel data detection section 33 in FIGS. 2, and S17 in FIG. 7). If errors that have occurred during transmission of image data (hereafter called transmission errors) are detected, the image processing circuit performs correction of image data, and generates image data that has had the transmission errors removed (refer, for example, to the pixel correction section 36 in FIGS. 2, and S147 in FIG. 13).

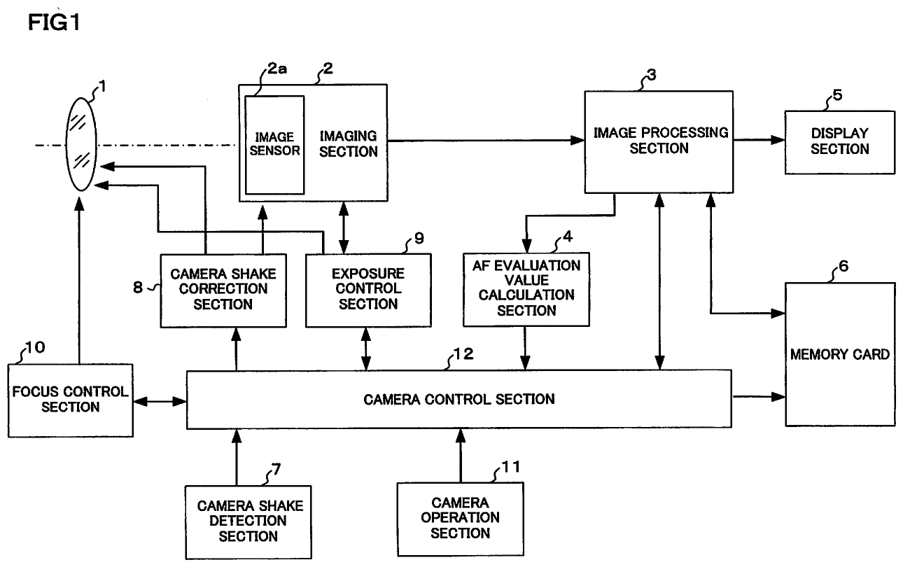

First, the camera of this embodiment will be described using FIG. 1. As shown in FIG. 1, this camera comprises an imaging section 2 having a lens 1 and an image sensor 2a, an image processing section 3, AF (autofocus) evaluation value calculation section 4, display section 5, memory card 6, camera shake detection section 7, camera shake correction section 8, exposure control section 9, focus control section 10, camera operation section 11, and camera control section 12. It should be noted that although the memory card 6 is described in FIG. 1, this memory card 6 is configured so as to be detachable from the imaging device, and so does not need to be specific to the imaging device.

The lens 1 is an imaging optical system that forms an optical image of the subject on the image sensor 2a. This lens 1 comprises a focus lens for performing focusing by adjusting focal position, and an aperture for controlling range of light flux that passes through, and may also be further provided with a camera shake correction function in this embodiment.

The imaging section 2 is provided with the image sensor 2a and an imaging processing circuit etc. and generates image information by subjecting an optical image of the subject that has been formed by the lens 1 to photoelectric conversion using the image sensor 2a, and outputs this image information as image data. Also, the image sensor 2a within the imaging section 2 of this embodiment may be provided with a camera shake correction function by configuring so that it is possible to move within a plane that is orthogonal to the shooting optical axis of the lens 1.

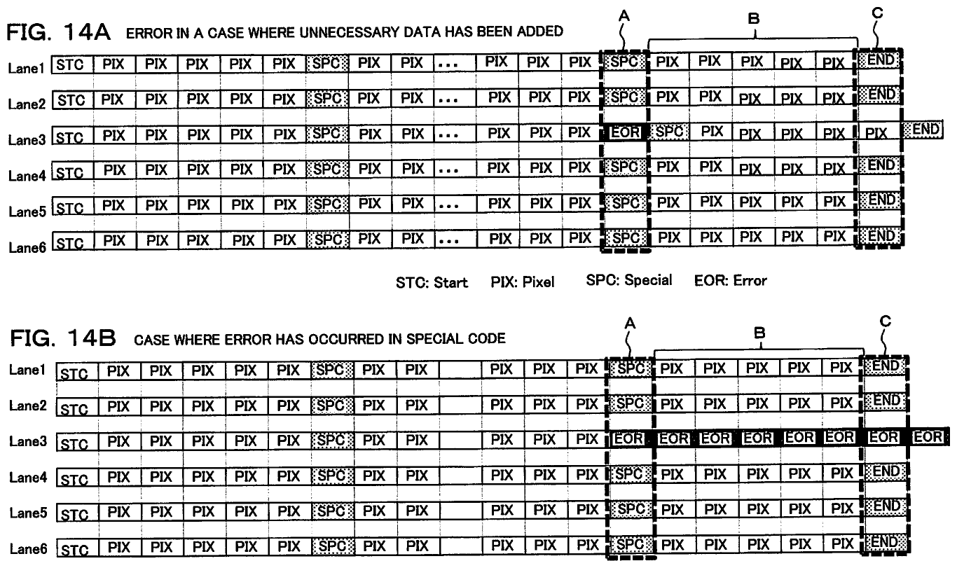

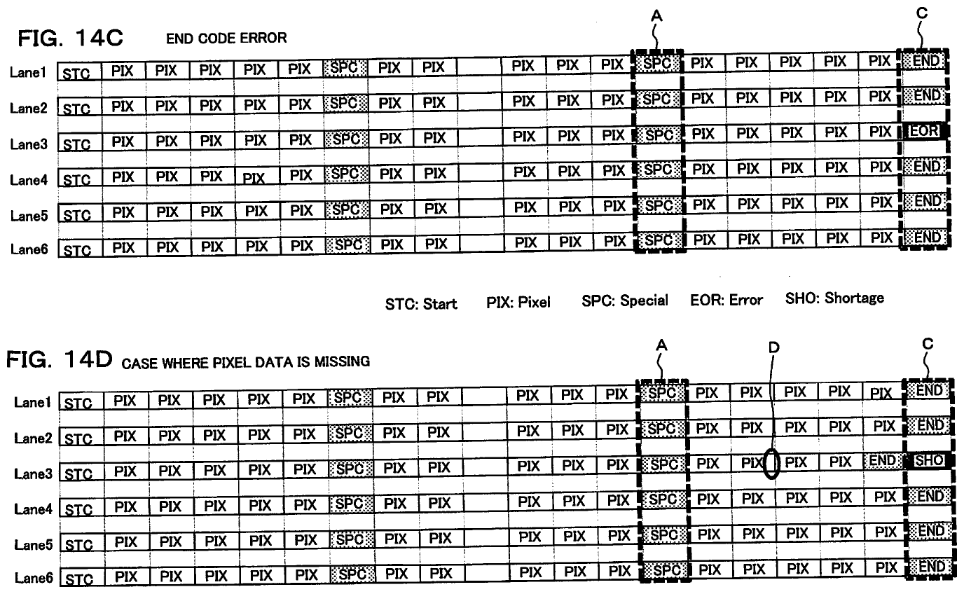

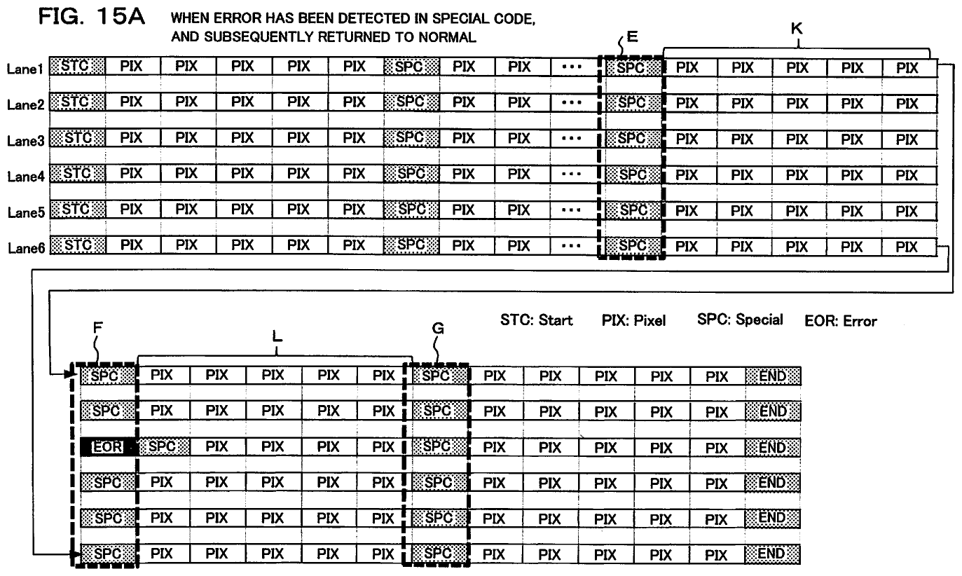

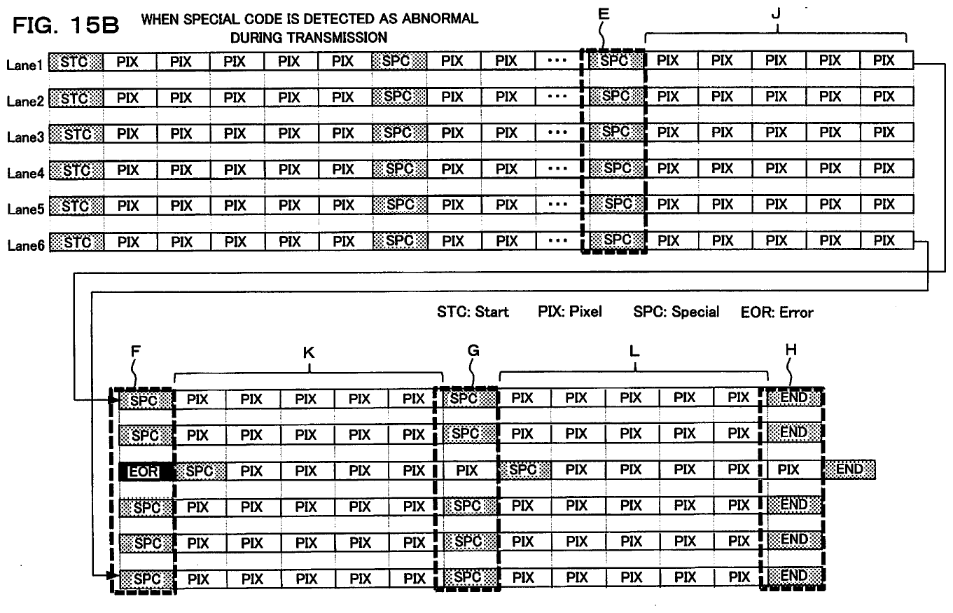

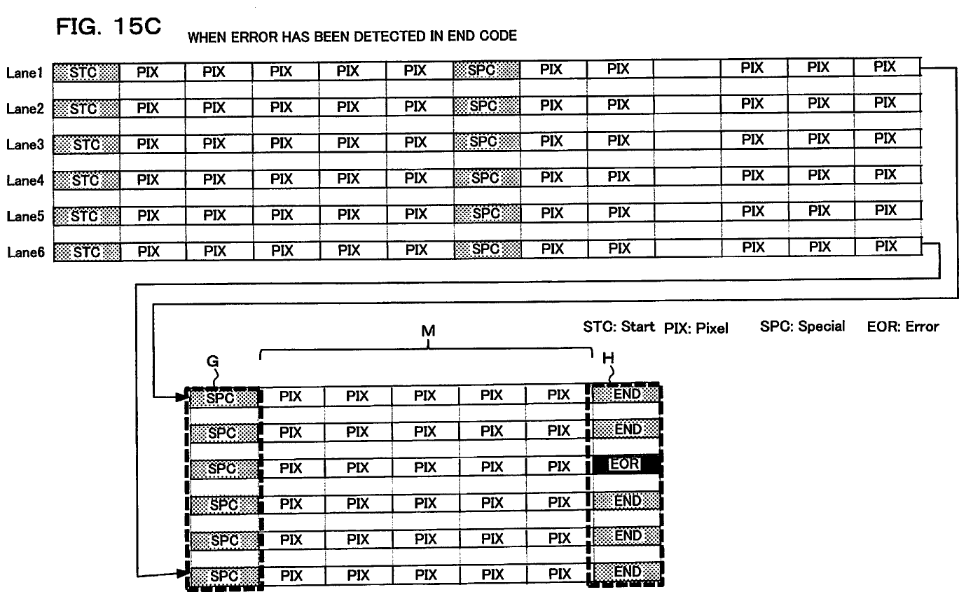

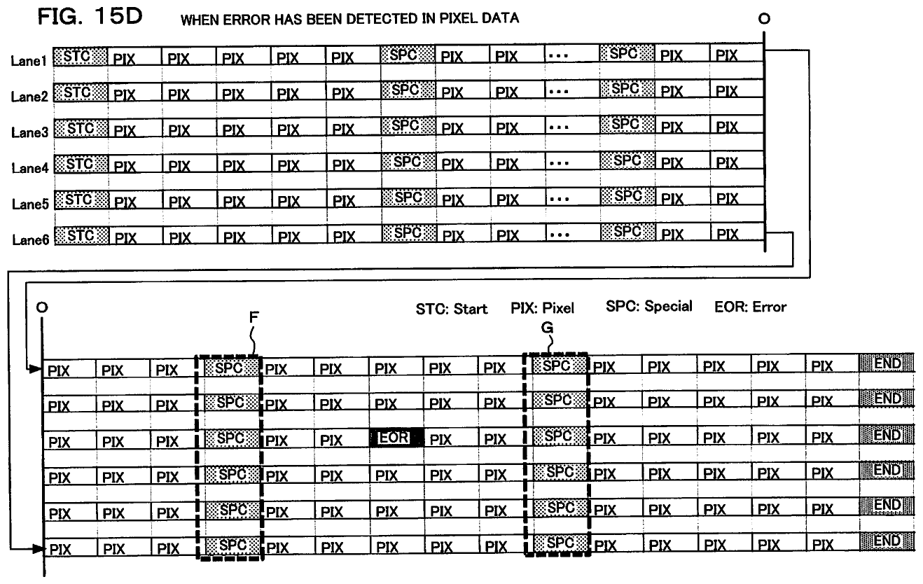

The imaging processing circuit within the imaging section 2 is provided with an A/D converter, and is provided with a parallel type A/D converter in order to achieve increase in speed, and it is possible to simultaneously convert a single line of pixel data to a digital signal. Also, as shown in FIG. 2 which will be described later, the imaging section 2 is provided with a transmission section 2b, and image data from this transmission section 2b is output to the image processing section 3. Image data has pixel data for a plurality of lines. Also, a start code, special code, and an end code etc., which will be described later, are included within the image data in addition to the pixel data. Special code is arranged at the same position within the same line of pixel data (refer, for example, to FIG. 14A to FIG. 15D).

The image sensor 2a has a plurality of pixels, and functions as an image sensor that forms an image using the plurality of pixels and outputs pixel data. The image sensor provides output by attaching special information to specified positions within lines of pixel data (refer, for example, to FIG. 14A to FIG. 15D). The image sensor provides output by attaching special information at the same position within a plurality of lines of pixel data that are transmitted synchronously in a plurality of lanes (refer, for example, to FIG. 14A to FIG. 15D).

The image processing section 3 is input with image data that has been output from the imaging section 2, and performs various image processing on the image data that has been input to generate image data for display or for storage. In the event that there are transmission errors in pixel data that has been output from the imaging section 2, the image processing section 3 performs detection of transmission errors and corrects the image data. Circuitry for this transmission error detection and performing image correction processing will be described later using FIG. 2. It should be noted that transmission errors are caused by power supply voltage of the imaging section 2 and image processing section 3 fluctuating, shifts in duty cycle of clock signal and a data signal in a transmission path, and degradation in waveform, etc. due to the influence of external noise such as static electricity.

If the image processing section 3 has performed image correction processing based on pixel data errors (transmission errors), as described above, then various image processing such as exposure correction and noise processing, WB gain correction, edge enhancement, false color correction etc., is applied to this image data that has been corrected or image data that has been saved in internal memory 30 (refer to FIG. 2). Further, the image processing section 3 also performs processing (development processing) to convert image data that has been subjected to the above described image processing to a stored data format etc.

The image processing section 3 in this embodiment is a dedicated image processing processor comprising an arithmetic circuit for performing image processing calculations. However, this structure is not limiting, and it is also possible to have a structure where, for example, image processing calculations are handled in a general purpose signal processing processor such as a digital signal processor (DSP), based on image processing programs. The structure is also not limited to a single chip processor, and there may be a multiple chip with functions divided.

The image processing section 3 functions as an image processing circuit that receives pixel data from an image sensor by means of a transmission path (refer, for example, to FIG. 2). The image processing circuit detects special information of a line of pixel data, and determines transmission errors of the transmission path based on detection results of the special information (refer, for example, to S17 in FIG. 7, and to FIG. 14A). The image processing circuit determines a transmission error if it is not possible to detect special information (refer, to S17 in FIG. 7, and to FIG. 14B).

The image processing circuit determines transmission errors based on position of the special information within lines of pixel data (refer, for example, to S17 in FIG. 7). A transmission path from the image sensor to the image processing circuit includes a plurality of lanes (refer, for example, to FIG. 14A to FIG. 15D). The image processing circuits determines whether or not a transmission error has occurred by comparing positions of the special information within pixel data lines across multiple lanes (refer, for example, to S17 in FIG. 7, and to FIG. 14A). The image processing circuit generates lines of pixel data that have information related to transmission errors attached, within pixel data lines, and stores these lines of pixel data in memory (refer, for example, to the pixel data detection section 33 in FIGS. 2, and to S19 in FIG. 7).

An AF evaluation value calculation section 4 receives image data that has been output from the imaging section 2 and subjected to processing in the image processing section 3, and calculates an AF evaluation value representing focused state. The AF evaluation value is output to the camera control section 12.

A display section 5 has a display for display, and displays images based on signals that have been subject to image processing for display by the image processing section 3. This display section 5 performs live view display, still image display immediately after shooting, playback display of still images that have already been stored, display during movie shooting, movie playback display etc. as well as display of various information relating to this camera.

The memory card 6 is a storage medium for saving signals that have been subjected to image processing for storage by the image processing section 3 (still image signals, movie signals etc.). This memory card 6 is an electrically rewritable non-volatile memory, and may be inserted into and taken out of the camera body, or may be fixed. Further, memory such as a hard disk may be used instead of the memory card.

The camera shake detection section 7 is configured having an acceleration sensor and an angular speed sensor etc., and detects movement that has been applied to the camera, for example, camera shake, and outputs detection results to the camera control section 12.

The camera shake correction section 8 moves at least one of the lens 1 and image sensor 2a so as to cancel out camera shake that has been detected, based on signals of the camera control section 12, and reduces the effects of camera shake on an optical subject image that has been formed on the image sensor 2a.

The exposure control section 9 controls an electronic shutter of the image sensor 2a (or an optical shutter when the camera is provided with an optical shutter) under control of the camera control section 12, based on shutter speed (exposure time) that has been determined by the camera control section 12, and causes an image to be acquired in the imaging section 2. Further, the exposure control section 9 also performs control of an aperture contained in the lens 1, based on an aperture value that has been determined by the camera control section 12.

The shutter speed and aperture value are determined by the camera control section 12 based on program diagrams etc. according to an apex system, for example, using metering data that has been calculated based on image signals output from the imaging section 2, and ISO sensitivity etc. that has been set using the camera operation section 11 (or has been automatically set by the camera control section 12). Also, the exposure control section 9 outputs drive information of the imaging section 2 to the camera control section 12.

The focus control section 10 drives the lens 1 in order to adjust focal position. Specifically, the focus control section 10 drives a focus lens contained in the lens 1 based on control of the camera control section 12 that has received the AF evaluation value from the AF evaluation value calculation section 4, so as to achieve focus for a subject image formed on the image sensor 2a. Also, the focus control section 10 outputs lens drive information, such as lens position, to the camera control section 12.

The camera operation section 11 is an interface for the user to instruct various operations to the camera. This camera operation section 11 includes operation members such as a power supply switch for turning the power supply of the camera on and off, a release button for inputting instruction of still picture shooting or movie shooting etc., and a mode dial for setting still picture shooting mode, movie shooting mode, live view mode, still picture/movie playback mode etc.

The camera control section 12 includes a CPU (central processing unit) etc. and is a processor that is made up of an ASIC (application-specific integrated circuit) including various peripheral circuits. This processor may be configured as a single processor, and may also be configured using a plurality of processors

The camera control section 12 performs overall control of the camera, including the image processing section 3, memory card 6, camera shake correction section 8, exposure control section 9, and focus control section 10 etc. based on lens drive information from the focus control section 10, AF evaluation value from the AF evaluation value calculation section 4, drive information of the imaging section 2 from the exposure control section 9, processing information from the image processing section 3, camera shake information from the camera shake detection section 7, and operational input from the camera operation section 11 etc.

Next, circuit portions for performing error detection and image correction processing, within the imaging section 2 and image processing section 3, will be described using FIG. 2.

In FIG. 2, the transmission section 2b for transmitting pixel data that has been read out from the image sensor 2a to the image processing section 3 is provided inside the imaging section 2. This transmission section 2b includes a transmission circuit, and divides pixel data for a single line of the image plane that has been read out from the image sensor 2a (for example, line y1 of image data shown at the bottom left of FIG. 2), and this pixel data that has been divided is transmitted to a data receiving section 31 of the image processing section 3 in parallel, using a plurality of lanes. By transmitting data in parallel in a plurality of lanes, it is possible to transmit pixel data at high speed. With this embodiment, transmission is performed with six lanes, as shown in FIG. 14A to FIG. 15D. In FIG. 2 the plurality of lanes have been simplified, and shown as a single lane.

The image sensor 2a is configured as a Beyer array having R pixels, G pixels, and B pixels arranged alternately in a two-dimensional array, as shown at the bottom left in FIG. 2. When transmitting pixel data, first, pixel data of line y1 is sequentially transmitted, followed by transmission of pixel data for line y2, line y3, . . . . When pixel data for one line is transmitted, a start code STC is positioned at a head portion, and pixel data is positioned after that, as shown by the image data between the transmission section 2b and the data receiving section 31. The start code STC is predetermined data, and is configured so that it can be distinguished from pixel data. The start code STC and the pixel data have the same number of bits. As will be described later, since the pixel data for line y1 is transmitted divided into a plurality of lanes, a start code STC is respectively positioned at the head portion of pixel data of each line of the plurality of lanes. Also, the image sensor 2a transmits with a special code arranged at predetermined positions within the pixel data of each line of the plurality of lanes. Similarly to the start code STC, the special code is also predetermined data, and is configured so that it can be distinguished from pixel data, and has the same number of bits.

With the example shown in FIG. 2, a head portion of image data that is transmitted from the transmission section 2b to the data receiving section 31 is start code STC1, followed by pixel data in the order of red pixel data Pr1, green pixel data Pg1, . . . red pixel data Pr2, green pixel data Pg2, then start code STC2, green pixel data Pg3, blue pixel data Pb3, green pixel data Pg4, blue pixel data Pb4.

The data receiving section 31, start code detection section 32, pixel data detection section 33, pixel data rearranging section 34, error information attachment section 35, pixel correction section 36, pixel data count section 37, error detection section 38, attached error information analysis section 39, and memory 30 are provided within the image processing section 3. Each of these sections is constructed as hardware circuitry, and operates based on control signals from the camera control section 12. It should be noted that each of the sections is not limited to hardware circuitry, and may be implemented as software, and may also be implemented by a combination of hardware and software.

The data receiving section 31 receives image data that has been transmitted from the transmission section 2b, divided across a plurality of lanes. This data that has been transmitted is image data that the image sensor of the imaging section 2 has formed into an image, at the bottom left of FIG. 2, and is image data having pixel data for line y1 and pixel data for line y2, . . . at the upper left arrange continuously and in order. Within this image data, as well as pixel data from each pixel of the image sensor 2a, there are also included a start code, a special code that will described later, and an end code, and further, data for merely empty information that does not have any information. The pixel data also includes data for error correction, such a parity check.

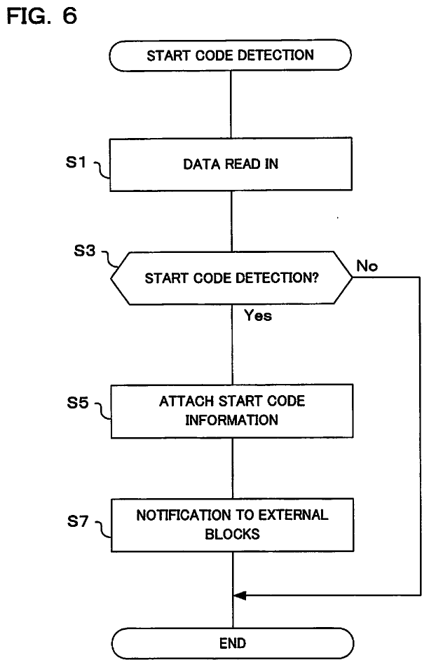

The start code detection section 32 is input with image data that has been output from the data receiving section 31, and detects a start code STC within this image data. As was described previously, within the image data, a start code STC is arranged immediately before pixel data of a head section of each line of the plurality of lanes. If this start code STC is detected, it is possible to detect a head position of pixel data of each line. If the start code detection section 32 detects a start code STC, start code detection is notified to the pixel data count section 37, error detection section 38, and error information attachment section 35. Detailed operation of this start code detection section 32 will be described later using FIG. 6.

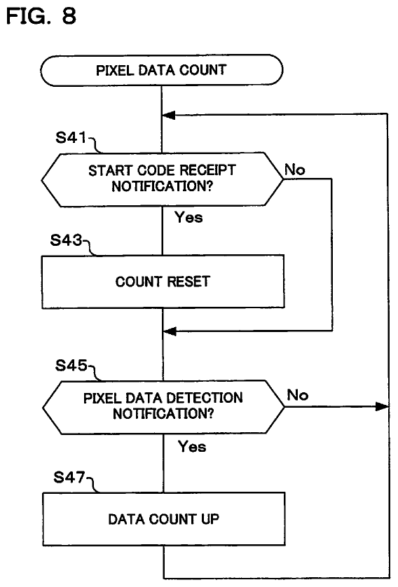

The pixel data count section 37 is a counter for counting positions of pixel data within image data. As was described previously, there is various data is contained within image data, as well as pixel data. However, since a start code is arranged at the head of the pixel data of each line, the pixel data count section 37 counts positions of pixel data with the start code as a reference. Detailed operation of the pixel data count section 37 will be described later using FIG. 8.

The pixel data detection section 33 is input with image data from the start code detection section 32, detects pixel data within this image data, and further performs error detection based on positions of special code etc. If the pixel data detection section 33 detects an error, error detection is notified to the pixel data count section 37 and the error detection section 38. Also, special code, error code, and end code is included within the image data, and if code such as this special code is detected, code information representing the position and code content of that code is notified to the pixel data rearranging section 34. The pixel data detection section 33 may also transmit code information to the pixel data rearranging section 34 using a separate signal in synchronization with image data, as shown in FIG. 2, and may also transmit code information as part of image data that has code information incorporated within image data to the pixel data rearranging section 34. Detailed operation of the pixel data detection section 33 will be described later using FIG. 7.

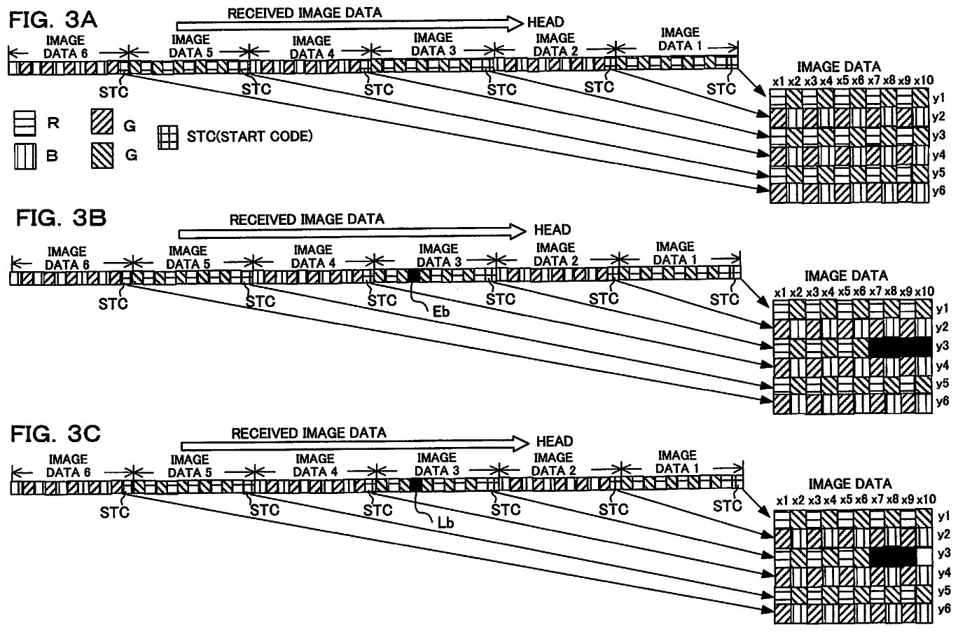

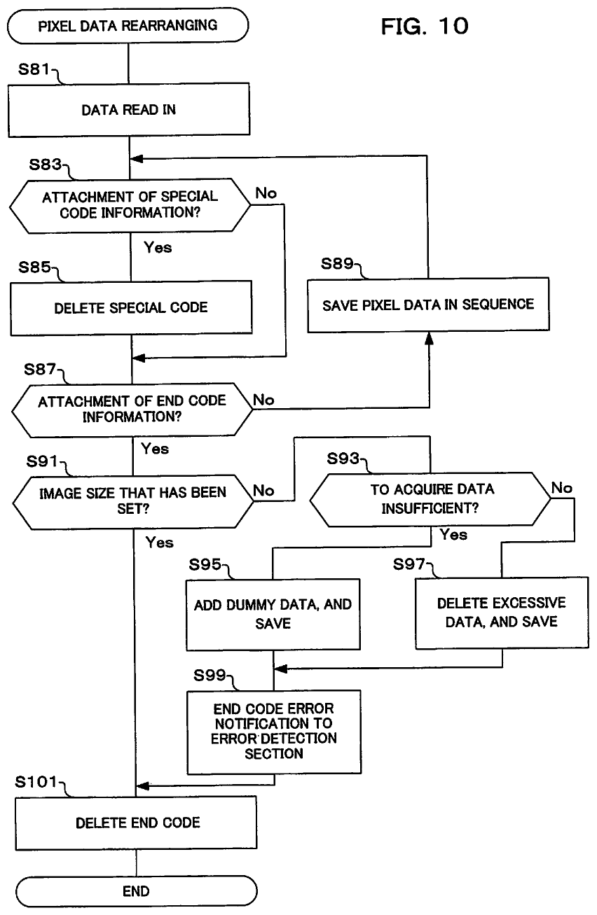

The pixel data rearranging section 34 is input with image data from the pixel data detection section 33, removes other than pixel data, such as start code, from within the image data, and adds dummy data to, or removes unnecessary data from, the image data, depending on whether there is insufficient data or too much data for a specified size of image data. If the pixel data rearranging section 34 detects an error, error detection is notified to the error detection section 38. Also, the pixel data rearranging section 34 performs processing to rearrange pixel data that has been divided into a plurality of lanes into an arrangement of pixel data for one line of an image plane. How the pixel data is rearranged in the pixel data rearranging section 34 will be described later using FIG. 3A to FIG. 3C, and detailed operation of the pixel data rearranging section 34 will be described later using FIG. 10.

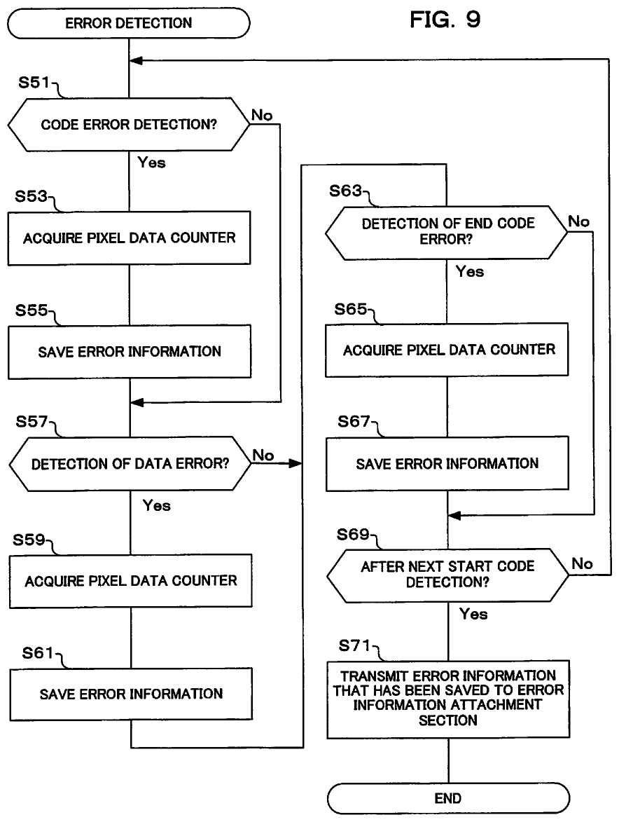

The error detection section 38 is input with count information (counter values) relating to positions of pixel data from the pixel data count section 37, is input with start code detection information from the start code detection section 32, and is input with error detection information from the pixel data detection section 33 and pixel data rearranging section 34. The error detection section 38 outputs error information to the error information attachment section 35 based on these items of information. Detailed operation of the error detection section 38 will be described later using FIG. 9.

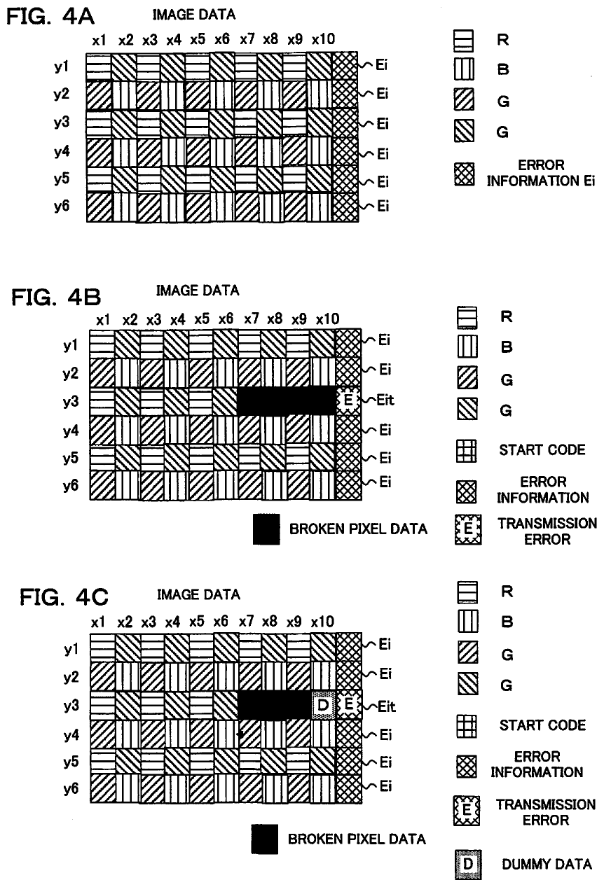

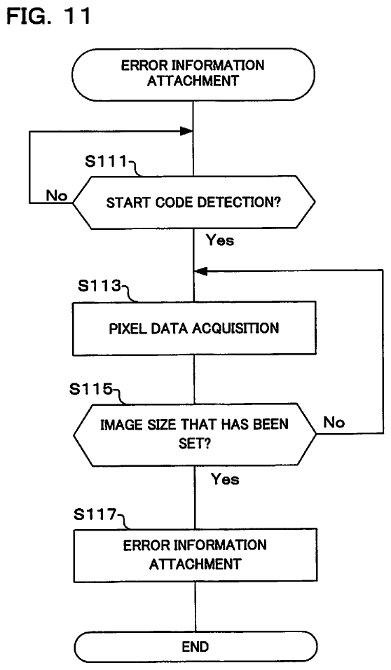

If the error information attachment section 35 is input with image data from the pixel data rearranging section 34 that only comprises pixel data, that is, if pixel data of one line of the image plane is acquired, then error information that has been input from the error detection section 38 is attached to the end of pixel data for one line of the image plane, to generate image data that contains error information. Attachment of error information in the error information attachment section 35 will be described later using FIG. 4A to FIG. 4C, and detailed operation of the error information attachment section 35 will be described later using FIG. 11.

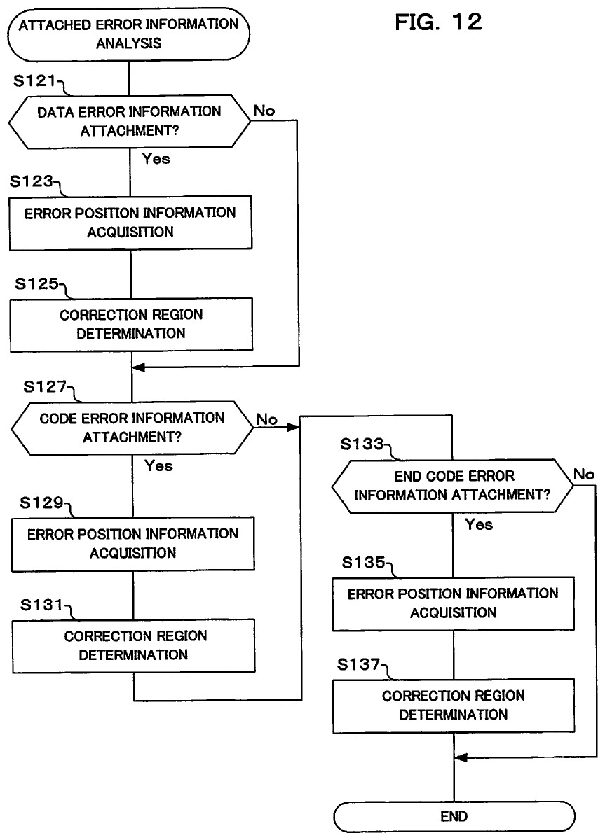

The attached error information analysis section 39 is input with image data that contains error information from the error information attachment section 35, analyzes range etc. for pixel correction based on the error information, and outputs correction instructions to the pixel correction section 36 based on the results of this analysis. Detailed operation of the attached error information analysis section 39 will be described later using FIG. 12, and correction range included in the correction instructions will be described later using FIG. 15A to FIG. 15D.

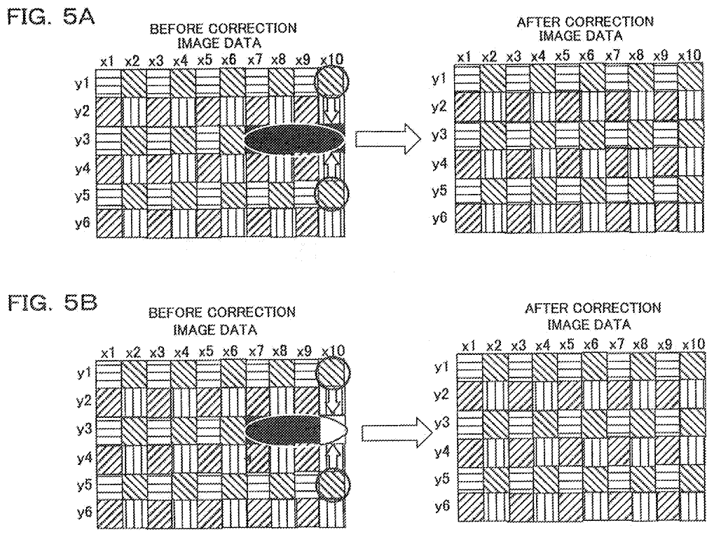

The pixel correction section 36 performs pixel correction based on correction instructions that have been input from the attached error information analysis section 39 on image data that has been input from the error information attachment section 35. Pixel correction processing in the pixel correction section 36 will be described later using FIG. 5A to FIG. 5B, and detailed operation of the pixel correction section 36 will be described later using FIG. 13.

The pixel correction section 36 functions as a correction circuit for correcting pixel data that has been received. The correction circuit corrects pixel data of a pixel data line (image data) that has been input from the error information attachment section 35, based on information relating to errors (correction instructions) (refer, for example, to FIG. 5A, FIG. 5B, and S147 in FIG. 13). The correction circuit corrects pixel data in accordance with error information, based on pixel data of a different line of pixel data to the pixel data corresponding to information relating to errors (correction instructions) (refer, for example, to FIG. 5A, FIG. 5B, and S147 in FIG. 13).

The memory 30 temporarily stores image data such as pixel data that has been subjected to processing in each section, in the image processing section 3. The memory 30 is an electrically rewritable nonvolatile memory, or an electrically rewritable volatile memory. The memory 30 functions as memory for storing pixel data.

Next, rearranging of pixel data by the pixel data rearranging section 34 will be described using FIG. 3A to FIG. 3C. FIG. 3A shows a normal case where pixel data that has been received from the data receiving section 31 (image processing section 3) does not contain any transmission errors. It should be noted that description of the plurality of lanes is omitted here for simplification, and a single lane of image data is transmitted. As was described previously, a start code STC is arranged at the head of each pixel data line, within the image data. Then, the start code STC of data that has been received by the data receiving section 31 and converted to serial data (received image data) is detected, and data up to detection of the next start code is made image data for a single line of the image plane. FIG. 3A (the same applies to FIG. 3B and FIG. 3C) shows from image data 1 (line y1) to image data 6 (line y6).

If image data of one line of the image plane within the serial data (received image data) is arranged sequentially in the vertical direction (columns), then it is possible to obtain 2-dimensional image data that has been imaged in the image sensor 2a, as shown in FIG. 3A. With the example shown in FIG. 3A, since there are no transmission errors in all of the pixel data pages showing normal image data.

FIG. 3B shows a case where transmission errors have occurred in pixel data Eb, and some of the data Eb is missing, resulting in pixel data that was received after this pixel data Eb being pixel values having different values. With the example shown in FIG. 3B, the 7th pixel data Eb of image data 3 is broken, for example, the number of bits is reduced, and so from that point onwards the positions of pixel data up to the next start code STC are shifted, and pixel data is not normal. With this example, pixel data from columns x7 to x10, within line y3 of the image data, is broken.

FIG. 3C shows a case where all of pixel data Lb is missing due to transmission errors. With the example shown in FIG. 3C, since the 7th pixel data Lb of image data 3 has been lost, from that point onwards one pixel data remains missing until the position of the next start code STC. With this example, pixel data from columns x7 to x9 within line y3 of the image data is broken, and pixel data for column x10 does not exist. The pixel data rearranging section 34 tidies up a number of pixel data that have had dummy data attached as pixel data at the position of column x10 in line y3 that is missing, to a specified number.

Next, attachment of error information by the error information attachment section 35 will be described using FIG. 4A to FIG. 4C. For image data that has been rearranged by the pixel data rearranging section 34 (FIG. 3A) the error information attachment section 35 attaches error information to the end of each line. FIG. 4A shows a case where all pixel data is normal, as was shown in FIG. 3A. In this case, error information Ei indicating that data is normal is attached to the end of each line.

FIG. 4B shows a case where, due to transmission error, pixel data becomes different after pixel data in which a transmission error has occurred, as was shown in FIG. 3B. In this case, error information indicating that data is normal is attached to the end of lines y1, y2, y4, y5, and y6. However, since pixel data for columns x7 to x10 is damaged in the case of line y3, and error information Eit indicating that an error is detected and that pixel data for columns x7 to x10 has been damaged is attached at the end of line y3.

FIG. 4C shows a case where pixel data in which a transmission error has occurred is missing because of the transmission error, and pixel data at the end of the image data for one line is missing, as was shown in FIG. 3C. In this case, error information indicating that data is normal is attached to the end of lines y1, y2, y4, y5, and y6. However, in the case of line y3 pixel data of column x7 is missing and pixel data for columns x7 to x10 is abnormal, and so error information Eit indicating that a transmission error has occurred at the position of columns x7 to x10 is attached at the end of line y3. It should be noted that dummy data D is added at the position of column x10 in line y3.

Next, pixel correction processing by the pixel correction section 36 will be described using FIG. 5A and FIG. 5B. Regarding pixel correction processing, correction is performed on pixel data for which errors have been detected, based on error information that has been attached to the end of each line of image data, using pixel data of lines above and below for which errors were not detected in the same column. The example shown in FIG. 5A is the same as the example that was described in FIG. 4B, and pixel data for positions of columns x7 to x10 in line y3 is missing. This line y3 has red (R) pixels and green (G) pixels arranged alternately, and so correction is performed using pixel data for the same column in lines y1 and y5 that have the same color arrangement as the pixel arrangement in line y3.

With the correction of FIG. 5A, pixel data for which error has been detected is compared with an average value of pixel data for which errors have not been detected that are arranged at positions of the same column of lines above and below the line for which errors were detected, and if the values are different the pixel data for which error was detected is replaced with this average value. For example, it is known that pixel data at the position of column x10 in line y3 is broken based on the error information Eit, and is replaced by average value of pixel data for positions where error was not detected in lines above and below line y3 (x10, y1) and (x10, y5). In this case, since pixel data for columns x1 to x6 in line y3 is not broken, correction processing is not applied. If correction processing is performed for the image data at the left side of FIG. 5A, then pixel data for columns x7 to x10 in line y3 is corrected to become normal values, and the image data overall becomes normal, as shown on the right side of FIG. 5A.

In the example shown in FIG. 5B, similarly to the example that was described in FIG. 4C, pixel data at the position of column x7 in line y3 is missing, and so the number of pixel data for line y3 is reduced by one. With this example also, pixel data for which error has been detected is compared with an average value of pixel data for a line in which errors have not been detected that are arranged at positions of the same column of lines above and below the line for which errors were detected, and if the values are different the pixel data for which error was detected is replaced with this average value. Also, positions where pixel data is missing can be recognized from error information Eit and number of pixels. Also, with lines in which errors have been occurred, such as line y3, it is known, based on the error information Ei, that pixel data from columns x1 to x6 is not broken, and so correction processing is applied to these pixel data. If correction processing is performed for the image at the left side of FIG. 5A, then pixel data for columns x7 to x10 in line y3 is corrected to become normal values, and the image data overall becomes normal, as shown on the right side of FIG. 5B.

Next, operation for start code detection in the start code detection section 32 will be described using the flowchart shown in FIG. 6. The start code detection section 32 performs processing to detect start codes corresponding to a plurality of lanes in parallel, but for the purpose of simplification description will be given corresponding to one lane. If the operation for start code detection is commenced, first, data is taken in (S1). Here, the start code detection section 32 takes in image data, that has been received by the data receiving section 31, in predetermined bit number units, and saves in the memory 30. The predetermined bit number corresponds to pixel data for a single pixel, and also corresponds to data representing start code. As was described previously using FIG. 2, pixel data that has been read out from each pixel of the image sensor 2a is taken in, in the form of serial data sequentially from the upper left pixel, and a start code STC is arranged at the head of each pixel data line.

Once data has been taken in, it is next determined whether or not a start code has been detected (S3). The start code detection section 32 detects data of a predetermined bit number, of the image data, and detects whether or not there is a start code STC within this data. If the result of this determination is that the data that was taken in in step S1 is pixel data etc., and it is not a start code STC, this flow is terminated. Once the next data is taken in, processing starts from step S1.

On the other hand, if the result of determination in step S3 is that a start code STC has been detected, start code information is attached (S5). Since data in which the start code STC has been detected is not pixel data, the start code detection section 32 adds an identification signal for identifying that it is not pixel data within data of the start code STC.

Next, notification is performed to an external block (S7). Here, the start code detection section 32 notifies the fact that the image data that has been received is a start code STC to external blocks, namely to the pixel data count section 37, error detection section 38, and error information attachment section 35. This is in order to notify each section of the fact that, as a result of detecting the start code STC, the data that will be received next is pixel data for the head of that line. Once notification has been sent to the external blocks, the operation for start code detection is terminated. Once the next data is read in, processing starts from step S1.

Next, operation of pixel data detection in the pixel data detection section 33 will be described using the flowchart shown in FIG. 7. The pixel data detection section 33 processes pixel data corresponding to a plurality of lanes in parallel, but for simplification description is given of processing corresponding to a single lane. If the operation for pixel data detection is commenced, first, data is read in (S11). Here, the pixel data detection section 33 reads in image data that has been output from the start code detection section 32, and saves in the memory 30.

Once data has been read in, it is next determined whether or not it is valid data (S13). As was described previously, a start code STC is not pixel data, and the fact that it is not pixel data is stored as additional information in a header, not shown, positioned after the start code STC. The pixel data detection section 33 determines that it is valid data as long as the information that it is not pixel data has not been stored in the additional information of the header. If the result of determination in this step is that it is not valid data, the flow for pixel data detection is terminated.

If the result of determination in step S13 is that it is valid data, it is determined whether or not it is a special code (including an end code) (S15). A special code is data having the same number of bits as the pixel data, and arranged between specified pixel data and the next pixel data, in lines of each lane of image data. A special code is made up of data that can be discriminated from pixel data. A special code is arranged at the same position in each lane. This means that if the arrangement position of a special code is different to that in another lane, it is possible to infer that a transmission error has occurred at that position. It should be noted that because the special code is arranged at the same position in each lane, it can be used in adjustment of transmission speed for each lane of pixel data. In this step, the pixel data detection section 33 determines whether or not this data is a special code based on the content of data that was read out in step S11.

If the result of determination in step S15 was a special code (including an end code), it is next determined whether or not there is error detection with that special code (S17). As was described previously, the special code is arranged at the same position in each lane, which means that if that position is different to that in another line it is possible to determine that occurrence of a transmission error has been detected. Here, the pixel data detection section 33 performs this determination.

If the result of determination in step S17 is that an error has been detected, a code error is notified to the error detection section 38 (S19). Also, the pixel data detection section 33 notifies of the fact that an error (code error) relating to the special code has been detected to the pixel data count section 37 and the error detection section 38.

On the other hand, if the result of determination in step S17 is that error has not been detected, or if a code error was not notified to the error detection section in step S19, special code information is attached (S21). Here, if error was not detected the pixel data detection section 33 attaches the fact that the position and data of the special code is normal to the image data as information for the special code. Also, the pixel data detection section 33 attaches the fact that error has been detected to the image data as information of the special code if error has been detected. The pixel data detection section 33 may also transmit this information on the special code to the pixel data rearranging section 34 using a separate signal that is synchronized to the image data (FIG. 2).

If attaching information of the special code has been performed in step S21, it is next determined whether or not an end code has been detected (S23). Within the image data, an end code is arranged next to the final pixel data of a line corresponding to each lane. The end code is a kind of a special code, and has the same number of bits as the pixel data, and is made up of data that can be discriminated from other pixel data, a start code or a special code. In this step the pixel data detection section 33 determines whether or not an end code has been detected. If the result of this determination is that an end code has not been detected, processing returns to step S15.

If the result of determination in step S23 is that an end code has been detected, information of the end code is attached (S25). The pixel data detection section 33 attaches information in which an end code has been detected, namely an identification signal for identifying that there is an end code, within the end code.

If information on the end code has been attached, it is next determined whether or not it is after the next start code has been detected (S27). A start code STC is arranged at the head of each pixel data line corresponding to a plurality of lanes, and here, the pixel data detection section 33 determines whether or not a start code STC for the next pixel data line has been detected. If the next start code is detected, the flow for pixel data detection is terminated. Also, the detection of the next start code may be performed in step S23, the detection of an end code.

On the other hand, if the next start code has not been detected, processing returns to step S15, and it is determined whether or not a special code has been detected. If the result of this determination is that a special code is not detected, it is determined whether or not it is before end code detection (S29). As was described previously detection of end code is performed in step S23, and if the result of detection here is after end code has been detected (that is, before detection of the next start code), processing returns to step S15. If it is determined that there is not a special code in step S15, it can be determined that data that is arranged between the start code and the end code is pixel data. Also, it is determined that data after an end code has been detected is unnecessary data.

On the other hand, if the result of determination in step S29 is before end code detection, next, this is notified to the pixel data count section 37 (S31). As was described previously, since it is possible to determine that the data between the start code and the end code is pixel data, this is notified to the pixel data count section 37 and the pixel data count section 37 performs counting up of the number of pixel data (refer to S47 in FIG. 8).

Next, errors in the pixel data are detected (S33). Data for error correction, such as was described in patent publication 1, is attached to pixel data within the image data. In this step the pixel data detection section 33 determines whether or not an error in the pixel data has been detected based on the data for error correction. If the result of this determination is that an error has not been detected, processing returns to step S15.

On the other hand, if the result of determination in step S33 is that an error has been detected, a data error is notified to the error detection section 38 (S35). Here, the pixel data detection section 33 notifies the data error to the error detection section 38 and the pixel data count section 37. Once the error detection section 38 receives notification of the data error, a pixel data count value and error information are saved to the memory 30 (refer to S57, S59, and S61). Once error notification has been performed processing returns to step S15.

In this way, in the flow for pixel data detection, code errors are detected from position and data of a special code (S17, S19), an end code is detected (S23, S25), and data errors of the pixel data are detected (S33, S35). Also, if, during this processing, data that has been read in is pixel data, the fact that it is pixel data is notified to the pixel data count section 37.

Next, operation of pixel data count in the pixel data count section 37 will be described using the flowchart shown in FIG. 8. If the operation for pixel data count is commenced, it is first determined whether or not there has been notification of start code receipt (S41). As was described previously, if a start code STC is detected the start code detection section 32 notifies that fact to the pixel data count section 37 (refer to S7 in FIG. 6). Here, the pixel data count section 37 determines whether or not notification of start code detection has been received.

If the result of determination in step S41 is that notification of start code receipt has been received, count reset is performed (S43). Here, the pixel data count section 37 resets a counter for counting positions (number) of pixel data.

If count reset has been performed in step S43, or if the result of determination in step S41 is that there is no notification of starts code receipt, it is next determined whether or not notification of pixel data detection has been received (S45). The pixel data detection section 33 notifies detection of pixel data to the pixel data count section 37 every time pixel data for one pixel is detected, except for the case where a special code has been detected in the period from the start code detection to end code detection (refer to S31 in FIG. 7). Here, the pixel data count section 37 performs determination based on whether or not this notification has been received. If the result of this determination is that notification of pixel data detection is not received, processing returns to step S41.

If the result of determination in step S45 is that notification of pixel data detection has been received, count up of data is performed (S47). Here, the pixel data count section 37 increments a counter for pixel data. Once the count up has been performed, processing returns to step S41.

In this way, with the flow for pixel data count, after a start code STC has been detected (S41, S43) a counter is incremented every time pixel data for one pixel is received (S45). This means that the position (number) of pixel data that have been detected by pixel data detection section 33 is known by looking at the value of the counter of the pixel data count section 37 with the start code STC as a reference.

Next, operation of error detection in the error detection section 38 will be described using the flowchart shown in FIG. 9. If the operation for error detection is commenced, it is first determined whether or not a code error has been detected (S51). As was described previously, in the image data, special code is arranged at specified positions of each line of pixel data line of a plurality of lanes, and the pixel data detection section 33 determines whether or not a code error has been detected from this position, and if a code error has been detected notifies this fact to the error detection section 38 (refer to S17 and S19 in FIG. 7). In this step it is determined whether or not the error detection section 38 has received this code error notification.

If the result of determination in step S51 is that code error has been detected, the pixel data counter is acquired (S53). Here, the error detection section 38 acquires a counter value corresponding to positions within image data where a special code error (code error) has been detected, from the pixel data count section 37.

The error information is then saved (S55). Here, if the error detection section 38 detects an error of the special code, a counter value representing position of that error, and a counter value of a special code one before the special code for which an error was detected, are saved in the memory 30.

If error information has been saved in step S55, or if the result of determination in step S51 is that a code error was not detected, is next determined whether or not a data error has been detected (S57). As described previously, data for error correction is also included in pixel data, and if the pixel data detection section 33 has detected a data error based on this data, the fact that a data error has been detected is transmitted to the error detection section 38 (refer to S33 and S35 in FIG. 7). In this step, the error detection section 38 determines whether or not notification of a data error has been received from the pixel data detection section 33.

If the result of determination in step S57 is that data error has been detected, the pixel data counter is acquired (S59). Here, the error detection section 38 acquires a counter value corresponding to positions within image data where a data error has been detected, from the pixel data count section 37.

The error information is then saved (S61). Here, the error detection section 38 saves the information that the error was detected and a counter value representing position where the error was detected in the memory 30. There are various methods of error detection for pixel data, such as confirming data bits, such as parity check.

If error information has been saved in step S61, or if the result of determination in step S57 is that a data error was not detected, is next determined whether or not an end code error has been detected (S63). An end code error is detected in the pixel data rearranging section 34, in the flow for pixel data rearranging, which will be described later, and if an end code error is detected this is notified to the error detection section 38 (refer to S99 in FIG. 10). In this step it is determined whether or not notification of end code error has been issued.

If the result of determination in step S63 is that end code error has been detected, the pixel data counter is acquired (S65). Here, the error detection section 38 acquires a counter value corresponding to positions of image data where an end code error has been detected, from the pixel data count section 37.

The error information is then saved (S67). Here, if the error detection section 38 detects an end code error, information on whether the pixel data is insufficient or if there is too much is saved to the memory 30.

If error information has been saved in step S67, or if the result of determination in step S63 is that an end code error was not detected, is next determined whether or not a start code has been detected (S69). Empty data is arranged within image data, between an end code and the next start code STC. If the start code detection section 32 detects a start code STC, the fact that the start code has been detected is transmitted to the error detection section 38 (refer to S7 in FIG. 6). Here, the error detection section 38 performs determination based on whether or not a start code STC has been detected. If the result of this determination is that the next start code STC has not been detected, processing returns to step S51.

Next, if the result of determination in step S69 was that a start code was detected, error information that was saved is transmitted to the error information attachment section 35 (S71). Here, the error detection section 38 transmits the error information that was saved in steps S55, S61, and S67 to the error information attachment section 35.

In this way, in the flow for error detection, a type of error that has been detected in the pixel data detection section 33 and pixel data rearranging section 34, and a position within image data where that error was detected, are acquired, and these items of information are saved in the memory 30 as error information (S55, S61, S67). Then, acquisition of pixel data for one line is completed, and when transferring to the next pixel data line the error information that was saved is transmitted to the error information attachment section 35 (S71).

Next, operation of pixel data rearranging in the pixel data rearranging section 34 will be described using the flowchart shown in FIG. 10. The pixel data rearranging section 34 processes pixel data corresponding to a plurality of lanes in parallel, but here description is given of processing corresponding to a single lane. If the operation for pixel data rearranging is commenced, first, data is read in (S81). Here, the pixel data rearranging section 34 reads in image data that has been output from the pixel data detection section 33, and saves in the memory 30.

Once data has been read in, it is next determined whether or not there is special code information attachment (S83). If data that has been read in is a special code, that fact is attached to data (refer to S19 in FIG. 7). In this step the pixel data rearranging section 34 determines whether or not information on the fact that there is a special code is attached to the data that has been read in.

If the result of determination in step S83 is that special code information has been attached, the special code is deleted (S85). Data that has had information on the fact that there is a special code attached is not pixel data, but a special code, and is not necessary in blocks of subsequent stages, and so the special code, which is data that has information on the fact that there is a special code attached, is deleted.

Once the data that has information on the fact that there is a special code attached has been deleted in step S85, or if the result of determination in step S83 is that information on the fact that there is a special code has not been attached to data, it is next determined whether or not end code information is attached (S87). In a case where an end code has been detected in the data that has been read in, as was described previously, information on the fact that there is an end code within data is attached (refer to S23 and S25 in FIG. 7). In this step, the pixel data rearranging section 34 determines whether or not information on the fact that there is an end code is attached to data that was acquired in step S81.

If the result of determination in step S87 is that information on the fact that there is an end code is not attached, pixel data is sequentially saved (S89). If the data that has been read in is neither a special code or an end code, then since it is pixel data it is saved in the memory 30 in the order that it was read in. At this time, pixel data that has been divided into a plurality of lanes is consolidated and rearranged taking into consideration the order of pixel data, and then stored in memory 30. Once the pixel data has been saved, processing returns to step S83.

On the other hand, if the result of determination in step S87 is that information on the fact that there is an end code has been attached, it is determined whether or not the data is of an image size that has been set (S91). Since pixel data that has been read out from the image sensor 2a has an image size that has been set in advance, and all pixel data has been read out from after the start code until the end code, data amount of the pixel data that has been read in, and the image size, are collated. Therefore, the pixel data rearranging section 34 determines whether or not data volume of pixel data that was sequentially saved in the memory 30 in step S89 is the same as the data volume of image data that has been set in advance.

If the result of determination in step S91 is not the image size that has been set, it is next determined whether or not the acquired data is insufficient (S93). Here, the pixel data rearranging section 34 determines whether or not data volume of pixel data that was sequentially saved in the memory 30 in step S89 is smaller than the data volume of image data that has been set in advance.

If the result of determination in step S93 is that data is insufficient, then dummy data is added, the data is saved (S95). In this case, pixel data is missing, as was described in FIG. 3C, and for that reason there is a state where data amount of the pixel data is insufficient. Image size is therefore adjusted by adding dummy data in a data amount of the pixel data that is missing, and the data after the addition of dummy data is saved in the memory 30.

On the other hand, if the result of determination in step S93 is that the acquired data is not insufficient, namely that data amount is large, then excessive data is deleted and the data after deletion is saved (S97). In this case, since the pixel data is erroneously large, the size of the image data is adjusted by deleting data that is in excess of the set size, and the data after deletion is saved in the memory 30.

If data has been saved in step S95 or S97, then next, end code error is notified to the error detection section 38 (S99). Here, the pixel data rearranging section 34 notifies end code error to the error detection section 38 (refer to S63 in FIG. 9).

Once end code error has been notified in step S99, or if the result of determination in step S91 is that the size of image data that has been acquired is the size that has been set, next, deletion of the end code is performed (S101). Since the portion of data of end code is not pixel data, it is not required in subsequent blocks, and the pixel data rearranging section 34 deletes the portion of data of this end code. If the data portion corresponding to the end code has been deleted, the flow for pixel data rearranging is terminated.

With this flow for pixel data rearranging a data portion that has special code information attached is deleted, and rearranged to image data of only pixel data (refer to S81 to S89). Then, if information of an end code is detected it is determined whether or not data volume of image data that has been acquired is a size that has been set in advance. If the size of the image data is not as has been set, the size of the image data is changed to as has been set by addition of dummy data or deletion of excess data, and notification of end code error is performed (S91 to S99). Finally, a data portion to which end code information is attached is deleted (S101). If the flow for pixel data rearranging is completed, image data of only pixel data for one line is saved to the memory 30.

Next, operation of error information attachment in the error information attachment section 35 will be described using the flowchart shown in FIG. 11. If the operation for error information attachment is commenced, it is first determined whether or not a start code has been detected (S111). If the start code detection section 32 detects a start code STC, the fact that the start code has been detected is transmitted to the error information attachment section 35 (refer to S7 in FIG. 6). In this step, the error information attachment section 35 determines whether or not notification has been received from the start code detection section 32. If the result of determination in step S111 is that a start code STC has not been detected, detection of a start code STC is awaited.

If the result of determination in step S111 is that a start code has been detected, next, pixel data is acquired (S113). In this step, the error information attachment section 35 acquires the pixel data that was saved by the pixel data rearranging section 34 in step S89.

If pixel data has been acquired in step S113, it is next determined whether or not total size of a plurality of pixel data that has been acquired has an image size that has been set (S115). Here, it is determined whether or not the size of image data has reached an image size that has been set in advance, based on the amount of pixel data that was acquired in step S113. If the result of this determination is that it is not the image size that has been set, processing returns to step S113 and pixel data is sequentially acquired. The image size that has been set is, for example, data amount of all pixel data corresponding to one line of the image plane (in the example shown in FIG. 3A to FIG. 3C, line y1).

On the other hand, if the result of determination in step S115 is that the data has reached the image size that has been set, error information is attached (S117). Here, the error information attachment section 35 receives error information that was transmitted by the error detection section 38 in step S71, and attaches the error information that has been received at the end of a line of pixel data that has reached the image size that has been set. Once error information has been attached, the flow for error information attachment is terminated.

With the flow for error information attachment, error information is attached to the end of a pixel data line that has reached the image size that has been set, namely, to the very end of image data (refer to S117). Error information represents a type of code error, data error, or end code error, and position of the pixel data where that error was detected. The error information attachment section 35 transmits image data that has had the error information attached to the pixel correction section 36 (refer to FIG. 2).

Next, operation of attached error information analysis in the attached error information analysis section 39 within the pixel correction section 36 will be described using the flowchart shown in FIG. 12. If the operation for attached error information analysis is commenced, it is first determined whether or not data error information is attached (S121). Here, the attached error information analysis section 39 determines whether or not data error information is attached to error information positioned at the very end of a pixel data line that has been received from the error information attachment section 35. Data error Information shows that an error has been detected based on error correction data, such as parity check.

If the result of determination in step S121 is that data error information has been attached, then error position information is acquired (S123), and a correction region is determined (S125). Since information on error position is stored in the data error information, the attached error information analysis section 39 acquires this error position information. Also, if error position is known the attached error information analysis section 39 can determine a region in which to correct data error based on that position.

If the correction region has been determined in step S125, or if the result of determination in step S121 is that data error information has not been attached, it is next determined whether or not code error information is attached (S127). Here, the attached error information analysis section 39 determines whether or not code error information is attached to the error information. The code error information indicates that an error has occurred in data, because position of a special code has shifted, and it was not possible to detect a special code.

If the result of determination in step S127 is that code error information has been attached, then error position information is acquired (S129), and a correction region is determined (S131). Since information on error position is stored in the code error information, the attached error information analysis section 39 acquires this error position information. Also, if error position is known the attached error information analysis section 39 can determine a region in which to correct pixel data based on that position.

If the correction region has been determined in step S131, or if the result of determination in step S127 is that code error information has not been attached, it is next determined whether or not end code error information is attached (S133). Here, the attached error information analysis section 39 determines whether or not end code error information is attached to the error information. The end code error information indicates that an error has occurred in image data in a case where image size is more than or less than a set size, and in a case where end code cannot be detected.

If the result of determination in step S133 is that end code error information has been attached, then next, error position information is acquired (S135), and a correction region is determined (S137). Since information on error position is stored in the end code error information, the attached error information analysis section 39 acquires this error position information. Also, if error position is known the attached error information analysis section 39 can determine a region in which to correct pixel data based on that position. If the correction region has been determined in step S137, or if the result of determination in step S139 is that end code error information has not been attached, the flow for attached error information analysis is terminated.

In this way, with the flow for attached error information analysis, error position is acquired based on data error information, code error information, and end code error information, and a correction region for pixel data is determined from this position. The pixel correction section 36 performs pixel correction on the correction region for which a correction instruction was determined by the attached error information analysis section 39.

Next, operation of pixel correction in the pixel correction section 36 will be described using the flowchart shown in FIG. 13. Pixel correction is performed for every pixel data line. If the operation for pixel correction is commenced, it is first determined whether or not pixel correction is necessary (S141). Here, the pixel correction section 36 determines whether or not pixel correction is necessary based on a correction instruction, which is an analysis result from the attached error information analysis section 39. Specifically, if there is data error, code error, or end code error information, a correction instruction is received and it is determined that pixel correction is necessary. If the result of this determination is that pixel correction is not necessary, the flow for pixel correction is terminated.

If the result of determination in step S141 is that pixel correction is necessary, next, a correction start position and the correction end position are acquired (S143). In the event that pixel correction is performed, there may be cases where correction is performed not only for the error position, but also at positions before and after the error position. In this step the pixel correction section 36 acquires a range in which pixel correction will be performed (correction region), included in the correction instruction. This correction range will be described later using FIG. 15A to FIG. 15D.

If position of the correction range has been obtained in step S143, it is determined whether or not it is located at the correction start position (S145). Here, the pixel correction section 36 sequentially changes designated position of the pixel data, for pixel data that was acquired in step S113, and determines whether or not this position of pixel data is the correction start position.

If the result of determination in step S145 is that the correction start position has been reached, pixel correction is performed (S147). In this step, pixel correction section 36 commences correction of pixel data. There are various methods of correcting pixel data, for example, replacing with average value of pixel data for pixels of the same color positioned on lines above and below the correction start position (column). Also, obviously inappropriate pixel data may be corrected with an adaptive defective pixel correction method.

Next, it is determined whether or not the correction end position has been reached (S149). In this step, the pixel correction section 36 determines whether the designated position of pixel data is the correction end position for pixel correction. If the result of this determination is that the correction end position is not reached, processing returns to step S147 and pixel correction is performed for pixel data at the next position. Once the correction end position is reached, the flow for pixel correction is terminated.

In this way, with the flow for pixel correction, a region in which pixel correction is necessary, specifically, information on correction start position and correction end position, is acquired (S143). Then, pixel data is acquired by sequentially shifting position of the pixel data, and if position of the pixel data of the correction region is reached, correction processing is performed, such as replacing with an average value of data of the same color pixels in lines above and below. By performing this pixel correction on pixel data for which correction has been instructed, it is possible to obtain image data that has had transmission errors corrected.

Next, transmission errors within image data, and a region for pixel correction, will be described using FIG. 14A to FIG. 14D. FIG. 14A to FIG. 14D show start code STC, pixel data PIX, special code SPC, and end code END for each of a plurality of lanes. As was described previously, image data of a plurality of lanes is transmitted from the transmission section 2b of the imaging section 2 to the data receiving section 31 of the image processing section 3. These drawings FIG. 14A to FIG. 14D show image data that is transmitted from the transmission section 2b to the data receiving section 31.

FIG. 14A shows a case where a transmission error has occurred where unnecessary data is added to a third lane (hereafter called lane 3) among the plurality of lanes. Specifically, with the example shown in FIG. 14A a special code SPC is arranged in each lane, at the dashed line position A. However, unnecessary data has been added at the position of the special code SPC for lane 3, and so from that position onwards, until the position of the end code END, the position of the pixel data will be shifted (range B, range C). In this case, the pixel data detection section 33 determines that a special code error has occurred (refer to S17 in FIG. 7). Also, the position of the end code END for dashed line position C in lane 3 is shifted, and the number of pixel data is not correct, and so the pixel data rearranging section 34 determines an end code error (refer to S97 and S99 in FIG. 10). In this type of situation, since there is a special code error the pixel correction section 36 corrects pixel data of region B of data after the special code error has been detected.

FIG. 14B shows a case where a transmission error has occurred with special code in lane 3, among the plurality of lanes. Specifically, with the example shown in FIG. 14B a special code SPC is arranged in each lane, at the dashed line position A. However, after position A for the special code SPC of lane 3, there is a transmission error for all of the data. In this case also, similarly to the case of FIG. 14A, since position of the special code SPC in position A of lane 3 is not correct, the pixel data detection section 33 determines that a special code error has occurred, and since the number of pixel data does not agree with the set image size the pixel data rearranging section 34 determines an end code error (refer to S17 in FIGS. 7, and to S97 and S99 in FIG. 10). In this type of situation, since there is a special code error the pixel correction section 36 corrects pixel data of region B of data after the special code error has been detected.

FIG. 14C shows a case where a transmission error has occurred with end code END in lane 3, among the plurality of lanes. Specifically, with the example shown in FIG. 14C an end code END is arranged in each lane, at the dashed line position C. However, data for position of the end code END of lane 3 has a transmission error. In this case, since it is not possible to detect the end code END of lane 3, the pixel data rearranging section 34 determines end code error (refer to S97 and S99 in FIG. 10). The pixel correction section 36 corrects all pixel data PIX from the position of the special code SPC (dashed line position A) where it was determined that there was no special code error (normal) to the position of the end code END (dashed line position C). This is because there is a possibility of a transmission error having occurred in some or all of the pixel data PIX from the position of the special code SPC that was determined to not be a special code error to the position of the end code END where end code error was detected.

FIG. 14D Shows a case where a transmission error has occurred where pixel data PIX of lane 3, among the plurality of lanes, is missing. Specifically, with the example shown in FIG. 14D pixel data PIX is arranged between a special code SPC and a special code SPC (or end code END) of each lane. However, the case is shown where pixel data PIX is missing at position D for the pixel data PIX of lane 3. This means that the position of the end code END is in front of the normal dashed line position C by one pixel data, and since the number of pixel data of lane 3 does not now match a specified number, the pixel data rearranging section 34 determines an end code error (refer to S97 and S99 in FIG. 10). The pixel correction section 36 corrects all pixel data PIX from the position of the special code SPC (dashed line position A) where it was determined that there was no special code error (normal) to the position of the end code END (dashed line position C) where end code error was detected. There may be cases where the pixel data detection section 33 cannot detect that pixel data PIX is missing at position D, that is, cannot detect in which pixel data an error has occurred from position of the special code SPC for which it was determined that there was not special code error (dashed line position A) and position of the end code END where end code error was detected (dashed line position C). This is because in a case where all of one set of pixel data PIX is missing at position D, it is not possible to detect data error. There is thus a possibility of a transmission error having occurred in some or all of the pixel data from the position of the special code (dashed line position A) that was determined to not be a special code error (normal) to the position of the end code where end code error was detected (dashed line position C). A method for determining correction region will be described later.

Next, a method of determining correction region in the attached error information analysis section 39 will be described using FIG. 15A to FIG. 15D (refer to S125, S131, and S137 in FIG. 12). With the example shown in FIG. 15A to FIG. 15D image data that is transmitted from the transmission section 2b to the data receiving section 31 for a transmission path of six lanes is shown. In each drawing, image data of the six lanes is shown laterally, and so for each lane that is shown at the upper part, subsequent lanes are shown from the middle to the bottom part. A connection relationship is shown by solid line only in lane 1 and lane 6, but the same also applies for lane 2 to lane 5, where solid lines showing connections have been omitted.

FIG. 15A shows a case where special code error has been detected, transmission error has occurred at position of the special code SPC, and, from the next special code SPC to that onwards, becomes normal. In the example of FIG. 15A, special code SPC is positioned at the dashed line positions E, F, and G for each lane. However, in lane 3 a transmission error has occurred in data of position of the special code SPC for dashed line position F, and the special code SPC is moved to the position of the next pixel data PIX. In this way, although position of the special code SPC moves from dashed line position F of lane 3 because of the transmission error, a transmission error does not occur at dashed line position G and the special code SPC is arranged normally.

With the example shown in FIG. 15A, special code error is not detected at dashed line position E and dashed line position G, and special code error is determined at dashed line position F. Since there is a possibility of a transmission error having occurred in some or all of the pixel data PIX (regions K and L) between the special code SPC for dashed line positioned E and the special code SPC for dashed line position G, the attached error information analysis section 39 determines pixel data in a range between dashed line position E and dashed line position G to be a correction range. The pixel correction section 36 corrects a region of pixel data for in front of and behind dashed line position F where the special code error occurred, that is, region K and region L.

FIG. 15B shows a case where, when special code error has been detected, a transmission error occurs at the position of the special code SPC, and codes are also successively displaced from the next special code error onwards. In the example of FIG. 15B, special code SPC is positioned at dashed line positions E, F, G of each lane, and an end code END is positioned at dashed line position H. However, in lane 3 a transmission error occurs in data for the position of the special code SPC at dashed line position F, the special code SPC moves to the next position, and after that positions of pixel data PIX and special code SPC has shifted by one pixel data, and further pixel data is positioned at dashed line position H, and the end code END is positioned next to that. In this way, from dashed line position F onwards data moves to the next position by one pixel at a time.

In a case where special code error has been detected, there is a possibility that from the special code onwards pixel data PIX will be shifted, and so the attached error information analysis section 39 makes a region extending from the special code SPC for which error was detected, to the special code SPC where the next error was not detected (including the end code END), a correction region. Also, since there is a possibility of a transmission error occurring in some or all of the pixel data PIX from the special code SPC in which an error was not detected immediately before the special code SPC for which an error was detected, up to the special code SPC in which the error has been detected, and the data destroyed, the attached error information analysis section 39 then makes that region a correction region. In the example shown in FIG. 15B, the pixel correction section 36 corrects regions of pixel data PIX before and after the dashed line position where it was detected that an error had occurred, specifically, region J, region K, and region L.

FIG. 15C shows a case where end code error has been detected. With the example of FIG. 15C, an end code END is arranged in each lane, at dashed line position H. However, a transmission error has occurred in lane 3. In a case where it has been detected that end code error has occurred, the attached error information analysis section 39 makes a range spanning from the immediately previous special code SPC that was detected normally to the end code END a correction region. This is because there is a possibility that some or all of the pixel data from the immediately previous special code SPC that was detected normally to the end code END will be destroyed due to transmission error. With the example shown in FIG. 15C, the pixel correction section 36 corrects a region of pixel data from the special code that is at dashed line G to the end, namely region M.

FIG. 15D shows a case where it has been detected that a transmission error has occurred in pixel data. As was described previously, data for error correction, such as parity check, is incorporated in the pixel data. With the example shown in FIG. 15D, although special code is positioned at dashed line positions F, G, etc. an error is not detected in any of the special code. However, a data error is detected in the third pixel data from dashed line position F in lane 3. In this case, the pixel correction section 36 corrects pixel data for this third pixel position. It should be noted that whether or not pixel data PIX is normal may also be determined by detecting error correction data such as parity check. In this way, in the event that an error of pixel data PIX (data error) has been detected, only the pixel data for which data error has been detected is made a correction region.

As was described previously, with the imaging device of one embodiment of the present invention an image is formed using a plurality of pixels of an image sensor and pixel data is output, and pixel data is received from the image sensor via a transmission path (refer, for example, to FIG. 2). The image sensor provides output by attaching special information at specified positions within a line of pixel data (refer, to FIG. 14A and FIG. 14B), special information for a line of pixel data is detected, and a transmission error for the transmission path is determined based on results of detection of special information (refer, to the pixel data detection section 32 in FIGS. 2, and S17 in FIG. 7). As a result, errors are corrected and there is no reduction in image quality, even if large-scale transmission errors have occurred. Specifically, in the case of large-scale transmission errors, such as loss of data in pixel data units due to the effects of external noise such as static electricity, or pixel data increasing due to double transmission, correction of image data is not possible with error correction code. However, according to this embodiment it as possible to detect that large-scale transmission errors have occurred by detecting special information. If image correction processing is performed based on the results of this detection, there is no reduction in image quality.

It should be noted that with the one embodiment of the present invention, in addition to detecting transmission errors using special information, end code errors and data errors etc. are detected and correction is performed, but these may be omitted as appropriate, and other error detection methods may be employed.

Also, with the one embodiment of the present invention, arrangement of special code within the image data is at the same position in a plurality of lanes, but this is not limiting. The image sensor 2a may also have special data arranged at different predetermined positions in the plurality of lanes. Also, the image sensor 2a may have special code arranged at arbitrary predetermined positions. The image processing section 3 can detect special code based on predetermined positions. Also, the image sensor 2a they also have positions of special code that are not predetermined positions, but changed at random at the time of an imaging operation and transmission of image data. In this case, the image sensor 2a transmits arrangement information of the special code to the image processing section 3 before transmission of image data. The image processing section 3 special code within the image data based on arrangement information of the special code data has been received.

Also, with the one embodiment of the present invention, the camera control section 12 has been described as a processor that is comprised of a CPU, memory, and peripheral circuits etc. However, besides being constructed in the form of software using a CPU and programs, some or all of these sections may be constructed with hardware circuits, or may have a hardware structure such as gate circuitry generated based on a programming language described using Verilog, or may use a hardware structure that uses software, such as a DSP (digital signal processor). Suitable combinations of these approaches may also be used.

Also, the camera control section 12 is not limited to a CPU, and elements that fulfill the function as a controller may be used, and processing for each of the above described sections may also be performed by one or more processors that are configured as hardware. For example, each section may be a processor constructed as respective electronic circuits, and may be respective circuit sections of a processor that is constructed with an integrated circuit such as an FPGA (Field Programmable Gate Array). Alternatively, a processor that is constructed with one or more CPUs may execute functions of each section, by reading out and executing computer programs that have been stored in a storage medium.

Also, with this embodiment, an instrument for taking pictures has been described using a digital camera, but as a camera it is also possible to use a digital single lens reflex camera or a compact digital camera, or a camera for movie use such as a video camera or movie camera, and further to have a camera that is incorporated into a mobile phone, a smartphone a mobile information terminal, personal computer (PC), tablet type computer, game console etc., or a camera for medical use (for example, a medical endoscope), a camera for a scientific instrument such as a microscope, an industrial endoscope, a camera for mounting on a vehicle, a surveillance camera etc. In any event, the present invention may be applied to any device that transmits image data from an image sensor to an image processing section.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they may be downloaded via the Internet.

Also, with the one embodiment of the present invention, operation of this embodiment was described using flowcharts, but procedures and order may be changed, some steps may be omitted, steps may be added, and further, the specific processing content within each step may be altered.

Also, regarding operational flow within the scope of the patent claims, specification, and drawings, although description has been given using words expressing order, such as “first” and “next” for the sake of convenience, in places where there is no particular description, this does not mean that operating in this order is essential.

As will be understood by those having ordinary skill in the art, as used in this application, ‘section’, ‘unit’, ‘component’, ‘element’, ‘module’, ‘device’, ‘member’, ‘mechanism’, ‘apparatus’, ‘machine’, or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible to form various inventions by suitably combining a plurality of structural elements disclosed in the above embodiments. For example, some structural elements, among all the structural elements disclosed in the embodiments, may be omitted. Further, structural elements extending over different embodiments may be suitably combined.

What is claimed is:

1. An imaging device, comprising:
an image sensor that has a plurality of pixels, and outputs pixel data by forming an image using the plurality of pixels; and
an image processing circuit that receives the pixel data from the image sensor by means of transmission path; wherein
the image sensor attaches special information at specified positions within lines of pixel data and outputs the data, and
the image processing circuit detects the special information of the lines of pixel data, and identifies transmission errors for the transmission path based on results of detection of the special information.

2. The imaging device of claim 1, wherein:
the image processing circuit determines that there is the transmission error in a case where the special information cannot be detected.

3. The imaging device of claim 1, wherein:
the image processing circuit determines the transmission error based on position of the special information within the lines of the pixel data.

4. The imaging device of claim 3, wherein:
the transmission path includes a plurality of lanes;
the image sensor provides output by attaching the special information at the same position within a plurality of the lines of pixel data that are transmitted synchronously in the plurality of lanes; and
the image processing circuit determines the transmission error by comparing positions of the special information within the lines of pixel data across the plurality of lanes.

5. The imaging device of claim 4, wherein:
the image processing circuit comprises
memory for storing the pixel data, and
a correction circuit for correcting the pixel data that has been received, wherein
the image processing circuit generates lines of pixel data that have had information, relating to the transmission errors within the lines of pixel data, attached, and stores this pixel data in the memory, and
the correction circuit corrects pixel data of the pixel data lines that have been stored in the memory, based on the information relating to transmission errors.

6. The imaging device of claim 5, wherein:
the correction circuit performs correction based on pixel data of pixel data lines that are different to the pixel data lines corresponding to information relating to the transmission errors.

7. An imaging method for forming an image using a plurality of pixels of an image sensor and outputting pixel data, and receiving the pixel data from the image sensor by means of transmission path, the imaging method comprising:
attaching and outputting special information to specified positions within lines of pixel data; and
detecting the special information of the lines of pixel data, and identifying transmission errors for the transmission path based on results of detection of the special information.

8. The imaging method of claim 7, further comprising:
determining that there is the transmission error in a case where the special information cannot be detected.

9. The imaging method of claim 7, further comprising:
determining the transmission error based on position of the special information within the lines of the pixel data.

10. The imaging method of claim 9, wherein:
the transmission path includes a plurality of lanes;
and further comprising providing output by attaching special information at the same position within a plurality of the lines of pixel data that are transmitted synchronously in the plurality of lanes; and
determining the transmission error by comparing positions of the special information within the lines of pixel data across the plurality of lanes.

11. The imaging method of claim 10, further comprising:
storing the pixel data in memory;
generating lines of pixel data that have had information, relating to the transmission errors within the lines of pixel data, attached, and storing this pixel data in the memory; and
correcting pixel data of the pixel data lines that have been stored in the memory, based on the information relating to transmission errors.

12. The imaging method of claim 11, further comprising:
performing correction based on pixel data of pixel data lines that are different to the pixel data lines corresponding to information relating to the transmission errors.

13. A non-transitory computer-readable medium, storing a processor executable code, which when executed by at least one processor, that is arranged within an imaging device that forms an image using a plurality of pixels of an image sensor and outputs pixel data, and receives the pixel data from the image sensor by means of transmission path, performs an imaging method, the imaging method comprising:
attaching and outputting special information to specified positions within lines of pixel data; and
detecting the special information of the lines of pixel data, and identifying transmission errors for the transmission path based on results of detection of the special information.

14. The non-transitory computer-readable medium of claim 13, storing further processor executable code, which when executed by the at least one processor, causes the at least one processor to perform a method further comprising:
determining that there is the transmission error in a case where the special information cannot be detected.

15. The non-transitory computer-readable medium of claim 13, storing further processor executable code, which when executed by the at least one processor, causes the at least one processor to perform a method further comprising:
determining the transmission error based on position of the special information within the lines of the pixel data.

16. The non-transitory computer-readable medium of claim 13, storing further processor executable code, which when executed by the at least one processor, causes the at least one processor to perform a method further comprising:
providing output by attaching special information at the same position within a plurality of lines of pixel data that are transmitted synchronously in a plurality of lanes of the transmission path; and
determining the transmission error by comparing positions of the special information within the lines of pixel data across the plurality of lanes.

17. The non-transitory computer-readable medium of claim 16, storing further processor executable code, which when executed by the at least one processor, causes the at least one processor to perform a method further comprising:
storing the pixel data in memory;
generating lines of pixel data that have had information, relating to the transmission errors within the lines of pixel data, attached, and storing this pixel data in the memory; and
correcting pixel data of the pixel data lines that have been stored in memory, based on the information relating to transmission errors.

18. The non-transitory computer-readable medium of claim 17, storing further processor executable code, which when executed by the at least one processor, causes the at least one processor to perform a method further comprising:
performing correction based on pixel data of pixel data lines that are different to the pixel data lines corresponding to information relating to the transmission errors.
